(19) United States
(12) Patent Application Publication
(10) Pub. No.: US 2002/0021986 A1
(43) Pub. Date: Feb. 21, 2002

(54) Microplate sealer

(76) Inventors: Charles S. McCall, San Francisco, CA (US); Nicholas R. Kalayjian, San Francisco, CA (US); JonBen Bevirt, Emerald Hills, CA (US); Eric J. Rollins, Sonora, CA (US); Brian M. Sheldon, Palo Alto, CA (US)

Correspondence Address: HOWREY SIMON ARNOLD & WHITE LLP, 750 BERING DRIVE, HOUSTON, TX, 77057, US

(21) Appl. No.: 09/896,527

(22) Filed: Jun. 29, 2001

Related U.S. Application Data
(60) Provisional application No. 60/215,562, filed on Jun. 30, 2000.

(51) Int. Cl. B01L 3/00

(52) U.S. Cl. 422/99; 422/102

(57) ABSTRACT

An apparatus for sealing a microplate comprises a seal material and a seal advancer. The seal advancer is capable of capturing the seal material and pulling the seal material into the apparatus. The seal advancer may further include a moveable seal transfer plate having at least one vacuum pad. The seal transfer plate is capable of holding the seal material against a top surface of the seal transfer plate. When the seal transfer plate moves, the seal material sticks to the top surface moving along with the moving seal transfer plate. The apparatus further includes a touch screen monitor capable of displaying temperature and time parameters. The apparatus also includes a heat plate for sealing the seal material onto a top surface of the microplate and a plate carrier for moving the microplate into the apparatus.

The present application claims the benefit of co-pending U.S. Provisional Patent Application Ser. No. 60/215,562, which was filed on Jun. 30, 2000.

### FIELD OF THE INVENTION

The field of the invention is microplates, and more particularly, an apparatus for automatically sealing microplates.

### BACKGROUND OF THE INVENTION

A microplate is a tray with an array of discrete and separate sample wells. FIGS. 1a and 1b illustrate a microplate 10 with sample wells 12. The microplate 10 is generally used in the analysis of fluid samples, such as genetic testing. Typically, microliter quantities of fluid samples fill the wells 12. Generally, the fluid samples in the wells must be kept separate from each other. Additionally, the fluid samples in the wells sometimes must be stored for a period of time. Therefore, it is desirable to cover a top surface 14 of the microplate 10 with a lid or sheet of plastic material.

One difficulty in covering the top surface 14 of the microplate 10 is preventing the fluid samples from spilling. Rough movements of the microplate 10 can easily lead to spilling from the wells 12. Additionally, it is undesirable to have human hands directly touch the top surface 14 of the microplate 10. Furthermore, an apparatus that seals microplates should be able to accommodate microplates with different heights.

An apparatus that automatically seals microplates is desired. The microplate sealer should be compact in size and easy to use. The microplate sealer should be able to rapidly seal many microplates.

### SUMMARY OF THE INVENTION

According to one aspect of the present invention, there is provided an apparatus for sealing a microplate. The apparatus comprises a seal material and a seal advancer. The seal advancer is capable of capturing the seal material and pulling the seal material into the apparatus. The seal advancer may further include a moveable seal transfer plate having at least one vacuum pad. The seal transfer plate is capable of holding the seal material against a top surface of the seal transfer plate. When the seal transfer plate moves, the seal material sticks to the top surface moving along with the moving seal transfer plate. The apparatus also includes a plate carrier capable of moving the microplate into the apparatus. The apparatus also includes a heat plate capable of providing a temperature increase to melt the seal material onto the microplate. The seal material includes a first and second layer with the second layer that contacts the microplate having a lower melting point than the first layer. The apparatus may further include a display screen mounted within the apparatus. The display screen illustrates time and temperature parameters. The display screen may also include a touch screen to receive user inputs.

According to another aspect of the present invention, there is provided a method of feeding a seal material into a microplate sealer. The method comprises providing the seal material at an opening of the microplate sealer and advancing the end of the seal material through the opening with a vacuum force. The method may further include a step of holding the seal material against a plate and moving the plate within the sealer. The method may also include the steps of gripping the seal material within the microplate sealer and pulling the seal material further into the microplate sealer.

According to a further aspect of the present invention, there is provided a microplate sealer capable of sealing a microplate. The microplate sealer comprises a plate carrier, a heat plate and a seal material plane. The plate carrier is capable of holding the microplate and moving the microplate into the sealer. The seal material plane is a plane where a seal material is positioned for sealing onto the microplate. The heat plate is capable of moving down to the seal material plane, and the plate carrier is capable of the moving the microplate up to the seal material plane.

According to another aspect of the present invention, there is provided a microplate sealer for providing a seal over a top surface of a microplate. The microplate sealer comprises a plate transfer, a heat plate and a seal transfer plate. The plate transfer is capable of moving the microplate into the sealer. The seal transfer plate is capable of advancing a seal material into the sealer. The heat plate is capable of melting the seal material over the top surface of the microplate. The microplate sealer further includes a knife that is capable of cutting the seal material.

### BRIEF DESCRIPTION OF THE DRAWINGS

Other aspects and advantages of the invention will become apparent upon reading the following detailed description and upon reference to the drawings.

FIG. 1a is a top view of a microplate;

FIG. 1b is a side view of the microplate of FIG. 1a;

FIG. 2 is an isometric view of a microplate sealer according to one embodiment of the present invention;

FIG. 3 is a side view of the microplate sealer of FIG. 2 with a portion of the housing removed;

FIG. 4 is an isometric view of the microplate sealer of FIG. 2 with a portion of the housing removed;

FIG. 5 is a side view of the microplate sealer of FIG. 3 with a seal material fed into the microplate sealer;

FIG. 6 is a side view of the microplate sealer of FIG. 3 with a heat sealing plate lowered;

FIG. 7 is a block diagram of the microplate sealer according to one embodiment of the present invention;

FIG. 8 is an isometric view of a microplate sealer according to another embodiment of the present invention;

FIG. 9 is a side view of the microplate sealer of FIG. 8 with a portion of the housing removed;

FIG. 10 is a side view of the microplate sealer of FIG. 8 with a plate carrier having moved a microplate into the sealer;

FIG. 11 is a side view of the microplate sealer of FIG. 8 with a seal transfer plate in its forward position;

FIG. 12 is a side view of the microplate sealer of FIG. 8 with a heat plate lowered; and

FIG. 13 is a block diagram of the microplate sealer according to one embodiment of the present invention.

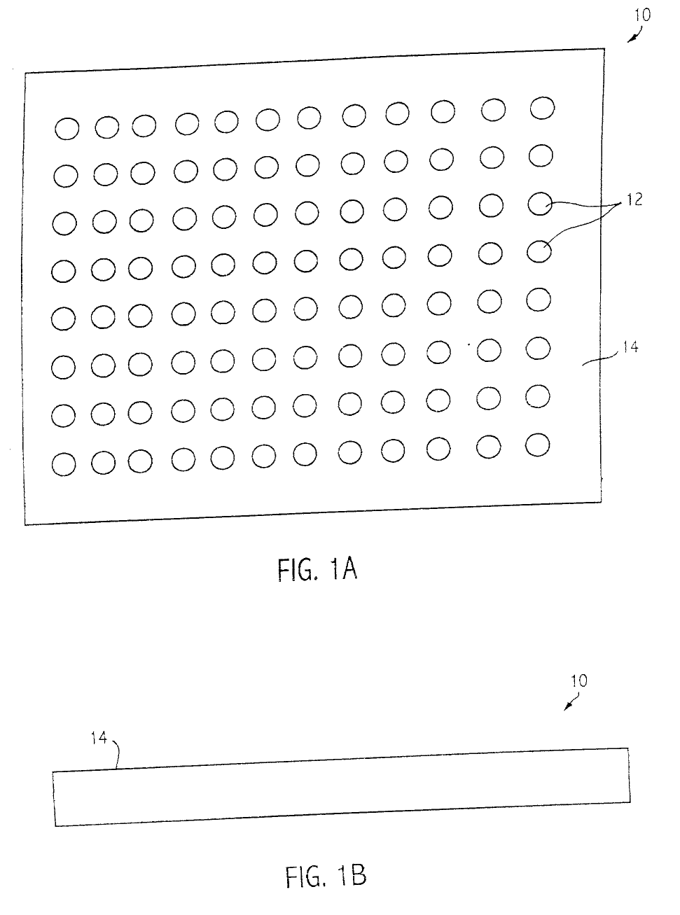

While the invention is susceptible to various modifications and alternative forms, specific embodiments thereof have been shown by way of example in the drawings and are herein described in detail. It should be understood, however, that the description herein of the specific embodiments is not intended to limit the invention to the particular forms disclosed, but on the contrary, the intention is to cover all modifications, equivalents, and alternatives falling within the spirit and scope of the invention as defined in the appended claims.

### DESCRIPTION OF ILLUSTRATIVE EMBODIMENTS

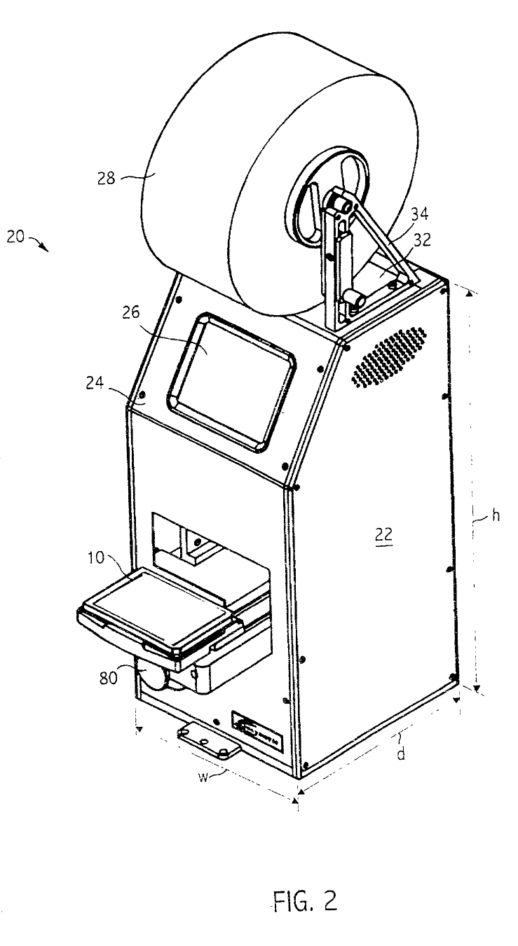

Turning now to the drawings and referring initially to FIG. 2, there is depicted a microplate sealer 20 of the present invention. The microplate sealer 20 includes a compact housing 22 having a height h of approximately 16 inches, a width w of approximately 8.5 inches and a depth d of approximately 8.5 inches. A front panel 24 of the housing includes a LCD touch screen monitor 26. The touch screen monitor 26, mounted directly within the microplate sealer 20, reduces the required interface space required for sealing the microplates 10.

The touch screen monitor 26 provides an on-screen program that allows a user to select heating times and heating temperatures for the various microplates 10 to be sealed. The touch screen monitor 26 displays various time and temperature parameters, and the user simply selects select the appropriate illustrated parameters on the touch screen monitor 26. The touch screen monitor 26 also displays a “start” button and a “stop” button. After the user has selected the appropriate time and temperature parameters, the user selects the “start” button to activate the microplate sealer 20. Once the microplate sealer 20 is operating, the touch screen monitor 26 displays a status such as “heating” with a countdown of time remaining. If the user wishes to stop the sealing process, the user may press the “stop” button on the touch screen monitor 26. Additionally, the microplate sealer 20 includes an emergency stop button 80 to stop the sealing process.

To seal the top surface 14 of the microplates 10, the microplate sealer 20 has a roll 28 of seal material 30. The seal material comprises two layers of plastic material, a top layer and a bottom layer. A bottom layer of the seal material 30 will engage and seal to the top surface 14 of the microplate 10. The plastic of the bottom layer of the seal material 30 has a lower melting point than the top layer. The top layer provides strength and puncture resistance to the seal. The width of the seal material 30 is approximately the width of the various microplates 10 to be sealed. The length of the seal material 30 is sufficient to seal hundreds or thousands of microplates 10 without requiring a new roll 28.

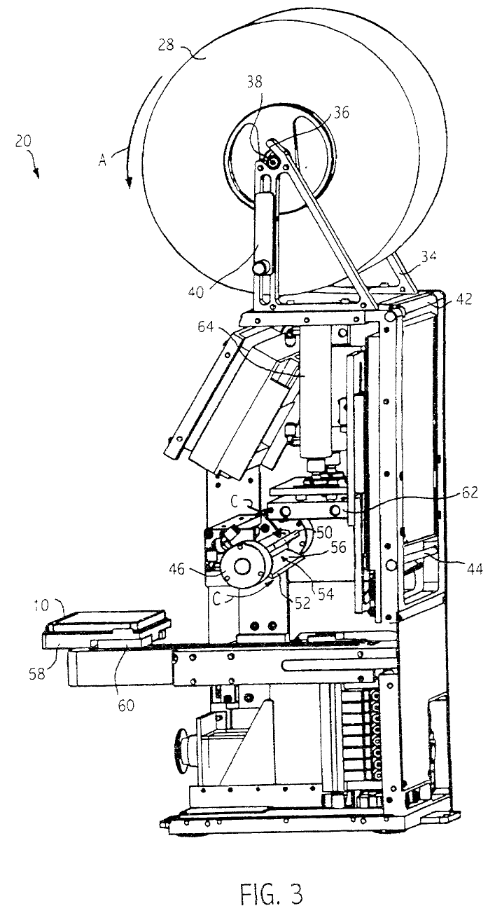

The roll 28 of seal material 30 is mounted on the top 32 of the microplate sealer 20 with a pair of mounting brackets 34. Referring to FIG. 3, the mounting brackets 34 provide a U-shaped hub 36 that holds an axle 38. The roll 28 of sheet material 30 fits around the axle 38. The axle 38 and roll 28 rotate in the direction of arrow A of FIG. 3 to feed the sheet material 30 into the microplate sealer 20. The mounting brackets 34 further include a seal tensioner 40 to lessen the free spin of the roll 28. As will be described in detail below, the seal material 30 is pulled into the microplate sealer 20. To prevent the roll 28 from rotating too far and creating slack in the sheet material 30, the seal tensioner 40 provides a friction force against the axle 38. The seal tensioner 40 is spring-loaded upward against the axle 38 to lessen the free spin of the roll 28.

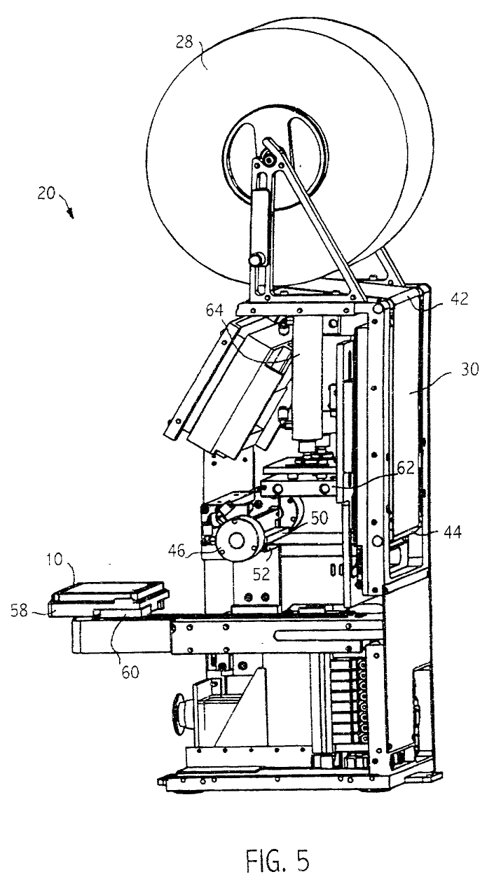

The seal material 30 unrolls from the roll 28 and passes over a first cylindrical bar 42 on the top 32 of the microplate sealer 20. From the first cylindrical bar 42, the seal material 30 passes downward along the back of the microplate sealer 20 to a second cylindrical bar 44. The seal material 30 then passes under the second cylindrical bar 44 and into the microplate sealer 20. FIG. 5 illustrates the seal material 30 unrolling from the roll 28, passing over the first cylindrical bar 42 and passing under the second cylindrical bar 44 into the microplate sealer 20.

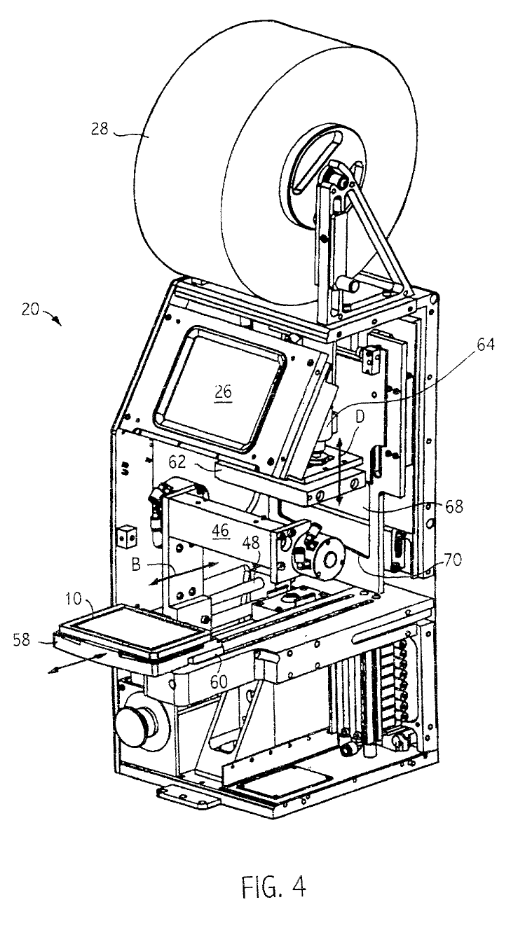

To pull the seal material 30 into the microplate sealer 20, the microplate sealer 20 includes a seal puller 46 as depicted in FIG. 3. The seal puller 46 moves along a pneumatic linear rail 48 (see FIG. 4) between a grasp position and a seal position. Arrow B illustrates the movement of the seal puller 46 along the linear rail 48. In the grasp position, the seal puller 46 is located at the back of the microplate sealer 20 to grasp the free end of the seal material 30. Once the seal puller 46 grasps the seal material 30, the seal puller 46 slides along the linear rail 48 towards the front of the microplate sealer 20 to the seal position. In the seal position, the seal material 30 is ready to engage the top surface 14 of the microplate 10.

To grasp the seal material 30 in the grasping position, the seal puller 46 includes an upper rotary gripping arm 50 and a bottom rotary gripping arm 52 that form jaws 54 to grasp the end of the seal material 30. As will be described in detail below, the bottom gripping arm 52 includes a vacuum pad 56 capable of holding the seal material 30 against the gripping arm 52. In FIG. 3, the gripping arms 50 and 52 are rotated away from each other to open the jaws 54 of the seal gripper 46. Arrows C illustrate the direction of rotation of the gripping arms 50 and 52 to closes the jaws 54. When the jaws 54 are open, the seal gripper 46 moves to the grasping position. In the grasping position, the end of the seal material 30 is adjacent the jaws 54 between the gripping arms 50 and 54. Once the end of the seal material 30 is near the jaws 54, the vacuum pad pulls the seal material 30 toward the gripping arm 52 and into the jaws 54. Once the seal material 30 is within the jaws 54, the gripping arms 50 and 52 rotate to closes the jaws 54 capturing the seal material 30.

FIG. 5 illustrates the gripping arms 50 and 52 closed on the seal material 30. With the seal material 30 captured between the gripping arms 50 and 52, the seal puller 46 moves from the grasping position to the sealing position along the linear rail 48. In the sealing position as shown in FIG. 5, the seal material 30 extends from the back of the microplate sealer 20 to the front of the microplate sealer 20, and the seal material 30 is in position for sealing onto the top surface 14 of the microplate 10. Once the seal material 30 is in position, the top gripping arm 50 rotates away from the seal material 30. Because the bottom gripping arm 52 includes the vacuum pad 56, the seal material 30 is held to the bottom gripping arm 52 by the vacuum. As will be described below in detail, the top gripping arm 50 rotates away from the seal material 30 to provide room for the lowering of a heat sealing plate 62.

To seal the top surface of the microplate 10 with the seal material 30, the microplate sealer 20 includes a plate carrier 58. The plate carrier 58 has a top surface that provides a platform on which the microplate 10 is placed with its top surface 14 facing upward. The plate carrier 58 includes edges to abut and align with the edges of the microplate 10. The plate carrier 58 moves in and out of the microplate sealer 20 on a pneumatic plate slider 60. When the plate carrier 58 is out of the microplate sealer 20, the user places the microplate 10 onto the plate carrier 58. The plate carrier 58 has dimensions for fitting numerous microplate types. In an alternative embodiment an automated process may place the microplate 10 onto the plate carrier 58, instead of the user placing the microplate 10 onto the plate carrier 58.

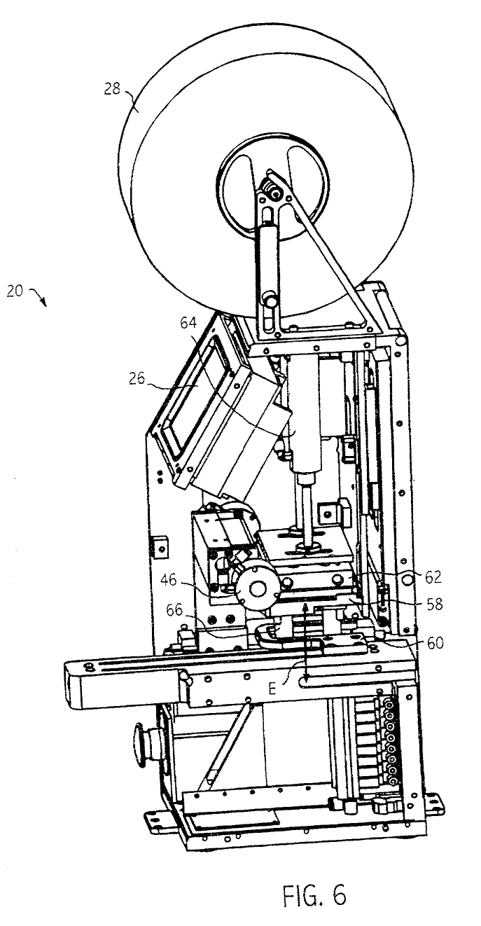

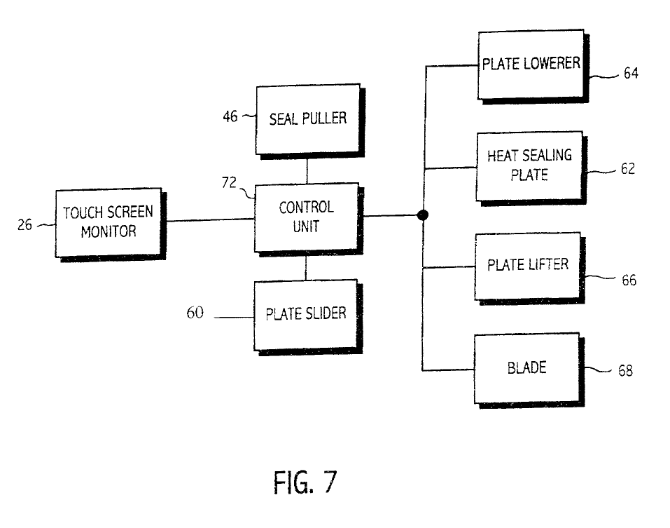

Once the microplate 10 is in position, the user pushes the “start” button on the touch screen monitor 26. The microplate 10 is then brought in to the microplate sealer 20 on the pneumatic linear plate slider 60. Once the microplate 10 is slid into the microplate sealer 20, the seal gripper 46 is in the sealing position and the seal material 30, held by the seal gripper 46, extends from the back to the front of the microplate sealer 20. To seal the seal material 30 to the top surface 14 of the microplate 10, the microplate sealer 20 includes a heat sealing plate 62. The heat sealing plate 62 raises and lowers between an upper position and a lower position. A pneumatic cylinder plate lowerer 64 raises and lowers the heat sealing plate 62 as illustrated with arrow D of FIG. 4. To seal the seal material 30 to the top surface of the microplate 10, a pneumatic plate lifter 66 raises the microplate 10 and plate carrier 58 to the seal material 30. The plate lifter 66 includes pneumatic cylinders that raise and lower the microplate 10 as illustrated with arrow E of FIG. 6.

The microplate sealer 20 adheres the seal material 30 to the top surface of the microplate 10 by lowering the heat sealing plate 62 into engagement with the seal material 30. The heat sealing plate 62 includes a plurality of vacuum ports that pull the seal material 30 against the bottom surface of the heat sealing plate 62. Once the seal material 30 is pulled against the heat sealing plate 62, the bottom gripping arm 52 releases its vacuum on the seal material 30 and rotates away from the seal material 30. This rotation by the bottom gripping arm 50 provides space for the plate lifter 66 to move the top surface 14 of the microplate 10 against the seal material 30. The microplate plate carrier 58 is lifted off the linear plate slide 60 by the vertical plate lifter 66 and raised to the point that the top surface 14 of the microplate 10 is pressed against the seal material 30 and heat sealing plate 62. The height that the plate carrier 58 is raised is automatically adjusted based on the height of the microplate 10. This is accomplished through the use of the pneumatically actuated cylinders of the plate lifter 66. The sealing pressure of the microplate 10 always remains consistent independent of microplate height because the sealing pressure is determined by the set pressure of the pneumatic cylinders of the plate lifter 66.

At the same time the microplate 10 is raised to the heat sealing plate 62, a sharp steel blade 68 slides down and cuts the seal material 30 at the rear of the microplate 10. The blade 68 works with a guillotine base 70 below the seal material 30 to produce a clean cut. After the cut, the remaining edge of seal material 30 connected to the roll 28 is ready to be pulled out for the next seal. Since the gripping arms 50 and 52 that originally grasp and pull the seal material 30 rotate away from the microplate 10, the seal material 30 is properly sized and positioned to cover up to the front end of the microplate 10. Additionally, the cut of the seal material 30 at the rear end of the microplate 10 provides that the seal material covering the microplate 10 is the size as the microplate 10. The microplate sealer 20 also eliminates any precut of the seal material and provides a simple and very fast process.

After the seal material 30 is pressed between the heat sealing plate 62 and top surface 14 of the microplate 10, the heat sealing plate 62 heats both the plastic of the seal material 30 and the entire top surface 14 of the microplate 10. The heat melts the bottom layer of the seal material 30 forming a thin layer of raised plastic on the top surface 14 of the microplate 10 around its wells 12. Upon removing the heat by raising the heat sealing plate 62 and lowering plate carrier 58, the layer of melted plastic cools, bonding the seal material 30 directly to the top surface 14 of the microplate 10 forming a very high quality seal.

Once the seal is formed, the plate lifter 66 drops the plate carrier 58 back into place on the plate slider 60. The plate slider 60 moves the microplate 10 out of the microplate sealer 20 and presents the fully sealed microplate 10 to the user. The microplate sealer 20 is instantly ready for sealing the next microplate 10.

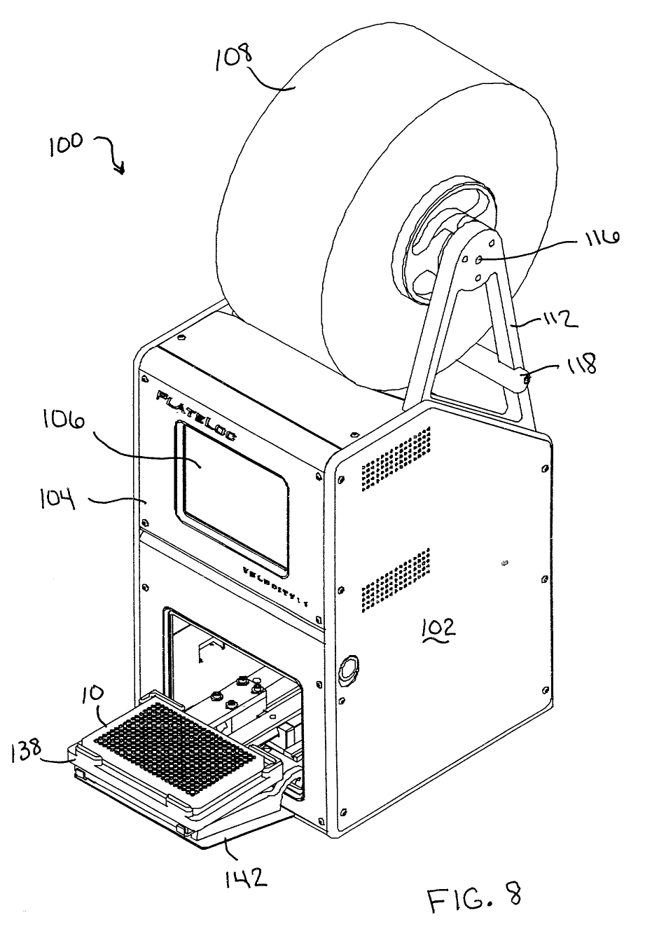

The microplate sealer 20 includes a control unit 72 such as a microprocessor with memory to coordinate the sealing operations. FIG. 8 illustrates a block diagram of the microplate sealer 20. The control unit 72 supports the LCD touch screen monitor 26 to provide the program options and status as described above. Because all of the motion within the microplate sealer 20 are provided by pneumatics, the control unit 72 provides the on/off signals to the seal puller 46, the plate slider 60, the heat plate lowerer 64, the plate lifter 66, and the blade 68. The control unit also provides the signal to heat the heat sealing plate 62 to the desired temperature for the predetermined time amount.

Turning now to FIG. 8, there is depicted another embodiment of a microplate sealer 100 according to the present invention. The microplate sealer 100 has a compact housing 102 with a front panel 104 including a LCD touch screen monitor 106. The touch screen monitor 106 provides an on-screen program that allows a user to select heating times and heating temperatures for the various microplates 10 to be sealed. The touch screen monitor 106 displays various time and temperature parameters, and the user simply selects select the appropriate illustrated parameters on the touch screen monitor 106. The touch screen monitor 106 also displays a “start” button and a “stop” button. After the user has selected the appropriate time and temperature parameters, the user selects the “start” button to activate the microplate sealer 100. Once the microplate sealer 100 is operating, the touch screen monitor 106 displays a status such as “heating” with a countdown of time remaining. If the user wishes to stop the sealing process, the user may press the “stop” button on the touch screen monitor 106.

To seal the top surface 14 of the microplates 10, the microplate sealer 100 has a roll 108 of seal material 110. The seal material 110 comprises two layers of plastic material, a top layer and a bottom layer. A bottom layer of the seal material 110 will engage and seal to the top surface 14 of the microplate 10. The plastic of the bottom layer of the seal material 110 has a lower melting point than the top layer. The top layer provides strength and puncture resistance to the seal. The width of the seal material 110 is approximately the width of the various microplates 10 to be sealed. The length of the seal material 110 is sufficient to seal hundreds or thousands of microplates 10 without requiring a new roll 108.

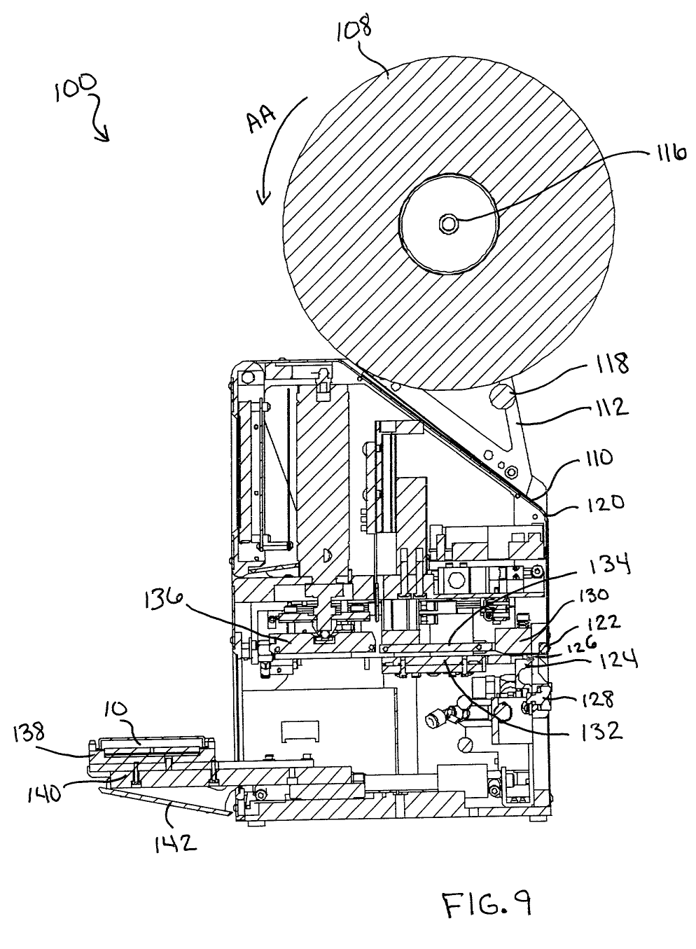

The roll 108 of seal material 110 is mounted at a top portion of the microplate sealer 100 with a pair of mounting brackets 112. Similar to the mounting brackets of FIG. 3, the mounting brackets 112 provide a hub 114 that holds an axle 116. The roll 108 of sheet material 110 fits around the axle 116. The axle 116 and roll 108 rotate in the direction of arrow AA of FIG. 9 to feed the sheet material 110 into the microplate sealer 100. The mounting brackets 112 further include a seal tensioner 118 to lessen the free spin of the roll 108. As will be described in detail below, the seal material is pulled into the microplate sealer 100. To prevent the roll 108 from rotating too far and creating slack in the sheet material 110, the seal tensioner 118 provides a friction force against the axle 116. The seal tensioner 118 is spring-loaded upward against the axle 116 to lessen the free spin of the roll 108. The seal material 110 unrolls from the roll 108 and passes over a first cylindrical bar 120 of the microplate sealer 100. From the cylindrical bar, the seal material 110 passes downward along the back of the microplate sealer 100 to a second cylindrical bar 122. The seal material 110 then passes under the second cylindrical bar 122 and into the microplate sealer 100.

For a new roll 108 of seal material 110, the user feeds a free end of the seal material 110 into the microplate sealer 100. The microplate sealer 100 includes a seal gripper 124 that may be pressed downwardly to open a slot 126 into the microplate sealer 100. Once the seal gripper 124 is pressed down, a gripper latch 128 snaps out to hold the seal gripper 124 in an open position. In its open position as illustrated in FIG. 9, the seal gripper 124 is positioned a distance away from a gripper back 130 to provide the slot 126 having a sufficient opening to allow easy feeding of the sealing film 110 into the microplate sealer 100. With the seal gripper 124 in the open position, the free end of the seal material 110 is threaded into the slot 126. The free end of the seal material 100 threaded through the slot 126 passes between a seal transfer plate 132 and a vacuum gripper plate 134. Once the end of the seal material 110 hits the rear side of a heat plate 136, the seal material 110 has been properly loaded, and the user presses in the gripper latch 128 to close the slot 126 and move the seal gripper 124 up to a gripping position. In its gripping position, the seal material 110 is gripped between the seal gripper 124 and gripper back 130.

After the free end of the seal material 110 has been loaded into the microplate sealer 100, the microplate sealer 100 is ready to seal a microplate 10. To seal the top surface of the microplate 10 with the seal material 110, the microplate sealer 100 includes a plate carrier 138. The plate carrier 138 has a top surface that provides a platform on which the microplate 10 is placed with its top surface 14 facing upward. The plate carrier 138 includes edges to abut and align with the edges of the microplate 10. The plate carrier 138 moves in and out of the microplate sealer 100 on a pneumatic plate transfer slider 140. When the plate carrier 138 is out of the microplate sealer 100 as shown in FIG. 9, the user places the microplate 10 onto the plate carrier 138. The plate carrier 138 has dimensions for fitting numerous microplate types. In an alternative embodiment an automated process may place the microplate 10 onto the plate carrier 138, instead of the user placing the microplate 10 onto the plate carrier 138.

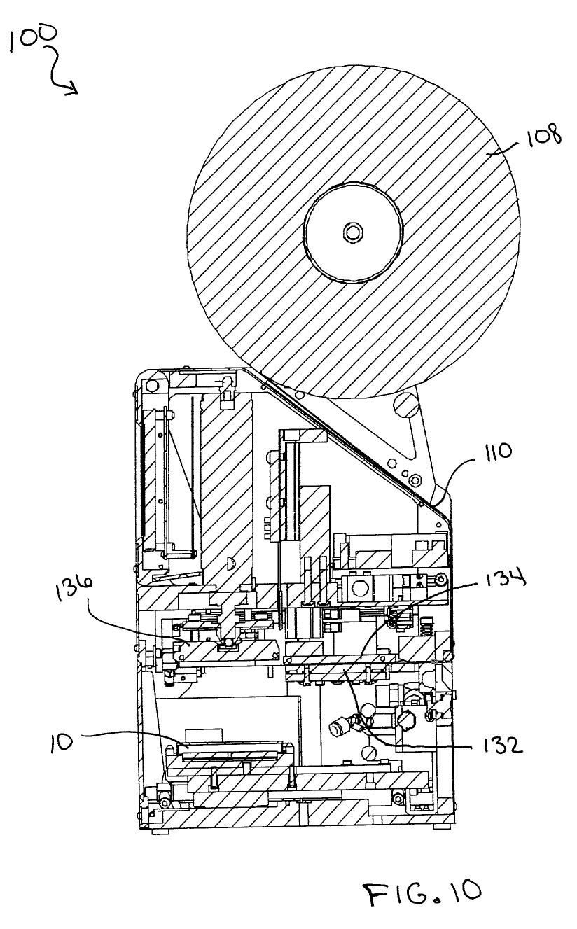

Once the microplate 10 is in position on the plate carrier 138, the user pushes the “start” button on the touch screen monitor 106. The microplate 10 is then brought into the microplate sealer 100 on the pneumatic linear plate transfer 140 from its exterior position to its sealing position. The front 104 of the microplate sealer 100 includes a plate door 142. When the plate carrier 138 is out of the housing 102, the plate door 142 is open. After the plate carrier 138 moves into the housing 102 of the microplate sealer 100, the plate door 142 automatically closes with a spring as shown in FIG. 10. The plate door 142 includes a door sensor (not shown) that prevents the operation of the microplate sealer 100 if the door is open. This safety feature reduces the risk of heat exposure to the user.

For sealing the microplate 10, the seal material 110 is automatically advanced into the microplate sealer 100. To automatically advance the seal material 110, the microplate sealer 100 includes the vacuum gripper plate 134 as depicted in FIG. 9 in its elevated position. The vacuum gripper plate 134 moves pneumatically down to its gripping position as shown in FIG. 10. In its gripping position, the vacuum gripper plate 134 contacts the seal material 110 onto the seal transfer plate 132. Once the seal material is gripped between the vacuum gripper plate 134 and seal transfer plate 132, vacuum pads within the seal transfer plate 132 turn on pulling the seal material against the surface of the seal transfer plate 132.

After the vacuum pulls the seal material 110 against the surface of the seal transfer plate 132, the vacuum gripper plate 134 moves pneumatically up to its elevated position. With the seal material stuck to the seal transfer plate 132, the seal transfer plate moves pneumatically forward from its back position to its forward position. When the seal transfer plate 132 moves forward, the seal material 110 is dragged forward pulling additional seal material 110 off of the roll 108 into the housing 102 through the closed seal gripper 124. Because the seal gripper 124 is closed, the seal material 110 is under tension as it moves along with the seal transfer plate 132 to prevent any wrinkles in the seal material 110.

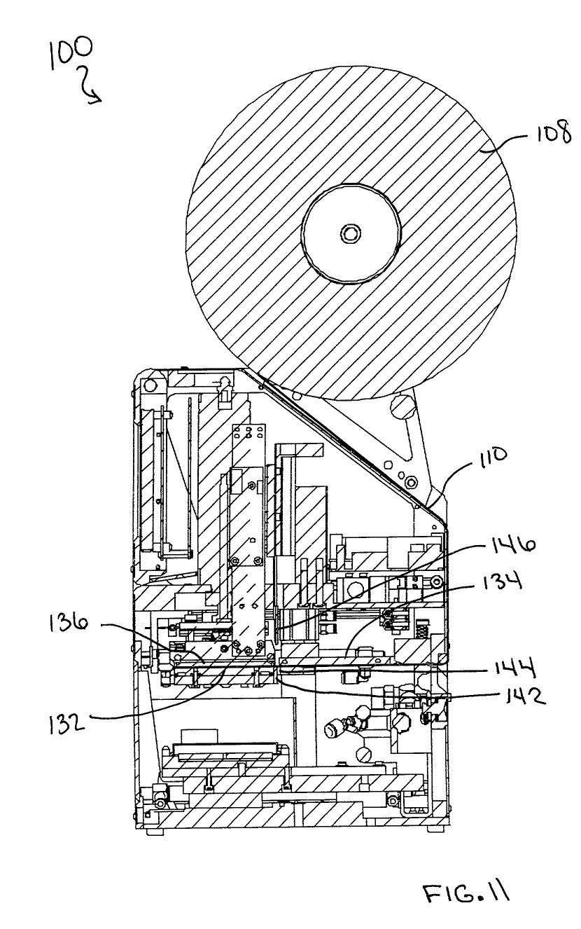

Once the seal transfer plate 132 is in its forward position as illustrated in FIG. 11, the heat plate136 moves down from its elevated position as seen in FIG. 10 to contact the seal material 110 on the seal transfer plate 132 as seen in FIG. 11. The vacuum gripper plate 134 also moves down to contact the seal material 110 against the back edge of the seal transfer plate 132 as depicted in FIG. 11. The seal material 110 is held firmly in place against the seal transfer plate 132 by the heat plate 136 and the vacuum gripper plate 134. The seal transfer plate 132 includes a bottom cutting blade 142 and a cutting slot 144. When the seal transfer plate 132 is in its forward position, a top cutting blade 146 aligns with the bottom cutting blade 142 and cutting slot 144. The seal material 110 is held firm on both sides of the cutting slot 144 by the surfaces of the seal transfer plate 132 and the heat plate 136 and vacuum gripper plate 134. The top cutting blade 146 moves downward and shears the seal material 110 between the top cutting blade 146 and bottom cutting blade 142.

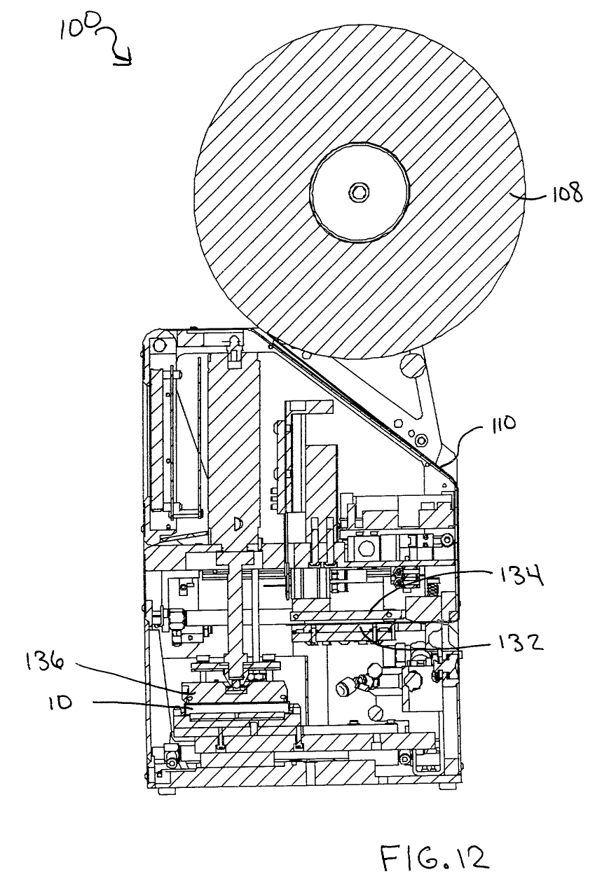

Once the seal material 110 has been cut to form the seal cover for the microplate 10 as shown in FIG. 12, the top cutting blade 146 returns to its elevated position, the vacuum in the seal transfer plate 132 is turned off and the vacuum in the vacuum gripper plate 134 is turned on. With the vacuum of vacuum gripper plate, the seal material 110 that is still attached to the roll 108 sticks to the surface of the vacuum gripping plate 134. The vacuum gripping plate 134 then moves upward to its elevated position carrying the seal material 100 with it. Once the seal cover for the microplate has been cut, a vacuum in the heat plate 136 turns on holding the seal cover against the heat plate's surface. The heat plate 136 then moves upward to its elevated position carrying the seal cover with it. Next, the seal transfer plate 132 slides to its back position away from the heat plate 136, and no seal material is attached to the seal transfer plate 132 at this time.

With the seal cover on the heat plate's surface, the heat plate 136 moves down to contact the microplate 10 as shown in FIG. 12. The height of the microplate 10 does not matter since the heat plate 136 will move downwardly until contacting the microplate 10. The same pressure is applied by pneumatics regardless of the heat plate's vertical position. Once the heat plate 136 and seal cover contact the top surface 14 of the microplate 10, the vacuum of the heat plate 136 turns off. Next, the heat plate 136 heats both of the plastic layers of the seal cover and the entire top surface 14 of the microplate 10. The heat melts the bottom layer of the seal material forming a thin layer of raised plastic on the top surface 14 of the microplate 10 around its wells 12. Upon removing the heat by raising the heat sealing plate 136, the layer of melted plastic cools, bonding the seal material 110 directly to the top surface 14 of the microplate 10 forming a very high quality seal. Once the seal is formed, the plate transfer 140 moves the microplate 10 out of the microplate sealer 100 and presents the fully sealed microplate 10 to the user. The microplate sealer 100 is instantly ready for sealing the next microplate 10.

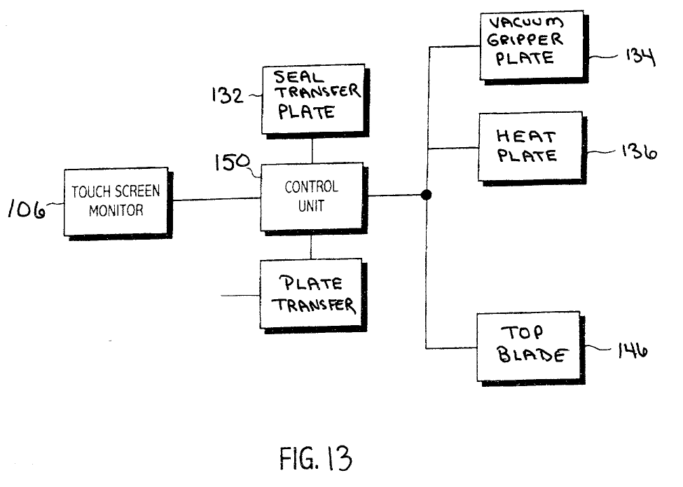

The microplate sealer 100 includes a control unit 150 such as a microprocessor with memory to coordinate the sealing operations. FIG. 13 illustrates a block diagram of the microplate sealer 100. The control unit 150 supports the LCD touch screen monitor 106 to provide the program options and status as described above. Because all of the motion within the microplate sealer 100 are provided by pneumatics, the control unit 150 provides the on/off signals to the seal transfer plate 132, vacuum gripper plate 134, heat plate 136, the plate transfer 140, and the top cutting blade 146. The control unit 150 also provides the signal to heat the heat sealing plate 136 to the desired temperature for the predetermined time amount. Furthermore, the control unit 150 provides on/off signals to turn on/off the vacuum pads associated with the seal transfer plate 132, vacuum gripper plate 134, and heat plate 136.

While particular embodiments and applications of the present invention have been illustrated and described, it is to be understood that the invention is not limited to the precise construction and compositions disclosed herein and that various modifications, changes and variations will be apparent from the foregoing descriptions without departing from the spirit and scope of the invention as defined in the appended claims.

What is claimed is:

1. An apparatus for sealing a microplate comprising:
a seal material; and
a seal advancer capable of creating a vacuum to capture said seal material and capable of pulling said seal material into said apparatus.

2. The apparatus of claim 1 wherein said seal advancer comprises a moveable seal transfer plate having at least one vacuum pad.

3. The apparatus of claim 2 wherein said seal transfer plate is capable of holding said seal material against a top surface of said seal transfer plate and when said seal transfer plate moves, said seal material sticks to said top surface moving along with said seal transfer plate.

4. The apparatus of claim 1 wherein said seal advancer comprises a upper gripping arm and a lower gripping arm, said upper and lower gripping arms capable of moving between an open position and a closed position.

5. The apparatus of claim 4 wherein one of said gripping arms includes at least one vacuum port.

6. The apparatus of claim 5 wherein said gripping arms in said closed position capture said seal material, said seal advancer capable of moving within said apparatus.

7. The apparatus of claim 1 further including a plate carrier capable of moving said microplate into said apparatus.

8. The apparatus of claim 7 wherein said plate carrier moves into said apparatus on a pneumatic slider.

9. The apparatus of claim 7 wherein said plate carrier is capable of moving up and down within said apparatus.

10. The apparatus of claim 1 further including a heat plate capable of providing a temperature increase to melt said seal material onto said microplate.

11. The apparatus of claim 10 wherein said heat plate includes a plate surface capable of holding said seal material against said plate surface with a vacuum.

12. The apparatus of claim 10 wherein said heat plate is capable of moving up and down within said apparatus.

13. The apparatus of claim 1 wherein said seal material comprises a roll of said seal material mounted on top of said apparatus.

14. The apparatus of claim 1 wherein said seal material comprises a first layer and a second layer, said first layer having a higher melting point than said second layer.

15. The apparatus of claim 14 wherein said second layer contacts a top surface of said microplate when said seal material is sealed onto said top surface of said microplate.

16. The apparatus of claim 1 further including a display screen mounted within said apparatus.

17. The apparatus of claim 16 wherein said display screen is capable of displaying time parameters.

18. The apparatus of claim 16 wherein said display screen is capable of displaying temperature parameters.

19. The apparatus of claim 16 wherein said display screen includes a touch screen capable of receiving a user input.

20. The apparatus of claim 1 further including a knife capable of cutting said seal material.

21. The apparatus of claim 20 wherein a length of seal material cut by said knife being a length to substantially cover said microplate.

22. The apparatus of claim 1 further including a controller located within said apparatus.

23. A method of feeding a seal material into a microplate sealer, said method comprising the steps of:
providing said seal material at an opening of said microplate sealer;
advancing said seal material through said opening with a vacuum force.

24. The method of claim 23 further including holding said seal material against a plate and moving said plate within said microplate sealer.

25. The method of claim 23 further including the step of gripping said seal material within said microplate sealer and pulling said seal material further into said microplate sealer.

26. The method of claim 23 wherein said advancing step comprises holding said seal material against a surface of a plate with said vacuum force and moving said plate within said microplate sealer.

27. A microplate sealer capable of sealing a microplate, said microplate sealer comprising:
a plate carrier capable of holding a microplate;
a heat plate capable of moving up and down within said sealer, and
a seal material plane wherein a seal material will be positioned for sealing onto said microplate; said plate carrier capable of moving said microplate up to said seal material plane.

28. The microplate sealer of claim 27 further including a pneumatic cylinder capable of moving said microplate up to said seal material plane.

29. The microplate sealer of claim 27 wherein said heat plate is capable of moving down to said seal material plane.

30. A microplate sealer for providing a seal over a top surface of a microplate, said microplate sealer comprising:
a plate transfer capable of moving said microplate into said sealer;
a heat plate; and
a seal transfer plate capable of advancing a seal material into said sealer.

31. The microplate sealer of claim 30, further including a knife capable of cutting said seal material.

32. The microplate sealer of claim 31 wherein a length of said seal material cut by said knife being a length to substantially cover said microplate.

33. The microplate sealer of claim 31 further including a vacuum gripper plate capable of gripping said seal material with a vacuum force.

34. The microplate sealer of claim 33 wherein said vacuum gripper plate capable of gripping said seal material between a plate surface of said vacuum gripper plate and a rear surface of said seal transfer plate, said heat plate capable of gripping said seal material between a heat plate surface of said heat plate and a front surface of said seal transfer plate.

35. The microplate sealer of claim 34 further including a knife capable of moving between said heat plate and said vacuum gripper plate to cut said seal material.

36. The microplate sealer of claim 31 wherein said heat plate includes a plate surface capable of holding said seal material against said plate surface with a vacuum.
